(19) United States
(12) Patent Application Publication
(10) Pub. No.: US 2022/0413522 A1
(43) Pub. Date: Dec. 29, 2022

(54) FLUID RESISTANCE ELEMENT AND FLUID CONTROL DEVICE

(71) Applicant: HORIBA STEC, Co., Ltd., Kyoto-shi, Kyoto (JP)

(72) Inventors: Tadahiro YASUDA, Kyoto-shi (JP); Andrew PRICE, Kyoto-shi (JP); Lei MA, Kyoto-shi (JP)

(21) Appl. No.: 17/771,714

(22) PCT Filed: Oct. 23, 2020
(86) PCT No.: PCT/JP2020/039940

§ 371 Date: Apr. 25, 2022

(30) Foreign Application Priority Data
Nov. 15, 2019 (JP) 2019-206878

(51) Int. Cl. G05D 7/06; G01F 15/00; G01F 1/36

(52) U.S. Cl. CPC G05D 7/0647; G01F 15/005; G01F 1/363

(57) ABSTRACT

To make it possible to incorporate a fluid resistance element into a flow path through which a fluid flows without difficulty while enjoying advantages from forming a resistance flow path using ceramic, provided is a fluid resistance element including: a ceramic flow path forming member having one or a plurality of resistance flow paths; and a metal covering member covering an outer peripheral face of the flow path forming member.

### TECHNICAL FIELD

The present invention relates to a fluid resistance element and a fluid control device including the fluid resistance element.

### BACKGROUND ART

A fluid resistance element has a flow path serving as resistance when a fluid flows (hereinafter, the flow path is also referred to as a resistance flow path), and, for example, a fluid flow rate can be measured based on pressures on an upstream side and a downstream side of the fluid resistance element when a fluid flows through the fluid resistance element.

As a fluid resistance element used in a flow rate control device for a material gas used for semiconductor manufacturing or the like, an extremely fine fluid resistance element is required in terms of accuracy of flow rate control, and a resistance flow path having a thickness of, for example, about several tens of μm is required in some cases.

To achieve this, for example in Patent Literature 1, a metal slit plate having a thickness of several tens of μm in which a plurality of slits is radially formed is sandwiched between a pair of covering plates so that the slit portion serves as a resistance flow path.

Such a fluid resistance element can make a fine resistance flow path, but when the slit plate is sandwiched between the covering plates, the slit plate having a thickness of several tens of μm is slightly bent. As a result, there is a problem that the resistance characteristics are changed by a slight error in pressure level at the time of sandwiching and fixing the slit plate with the covering plates, and it is difficult to stably produce a fluid resistance element having uniform resistance characteristics.

On the other hand, as shown in Patent Document 2, a ceramic fluid resistance element can be processed with high dimensional accuracy, which can be stably produced having uniform resistance characteristics.

However, when a ceramic fluid resistance element is fitted into a very thin flow path having a diameter of about several mm without a gap and the ceramic fluid resistance element has approximately the same diameter as the diameter of the flow path in the case of, for example, controlling a fluid of a low flow rate, the fluid resistance element is broken or damaged, and it is difficult to incorporate the fluid resistance element into a fluid control device.

### CITATION LIST

### Patent Literature

Patent Literature 1: JP 2011-257004 A
Patent Literature 2: JP S59-77027 U

### SUMMARY OF INVENTION

### Technical Problem

The present invention has been made to solve the above problems at once, and a main object of the present invention is to make it possible to incorporate a fluid resistance element into a flow path through which a fluid flows without difficulty while enjoying advantages from forming a resistance flow path using ceramic.

### Solution to Problem

That is, the fluid resistance element according to the present invention includes: a flow path forming member that is made of ceramic and has one or a plurality of resistance flow paths; and a covering member that is made of metal and covers an outer peripheral face of the flow path forming member.

The fluid resistance element configured as described above, which includes a flow path forming member made of ceramic, can be processed with high dimensional accuracy, and can be stably produced having uniform resistance characteristics. Specifically, for example, by cutting a long ceramic in which a resistance flow path is formed into pieces having a same length and using each of the pieces as the flow path forming member, it is possible to produce a lot of fluid resistance elements having uniform resistance characteristics. Since the flow path forming member is made of ceramic, the flow path forming member can be incorporated in a flow path through which a fluid flows without crushing the resistance flow path, and there are advantages such as a low thermal expansion coefficient, high corrosion resistance, and low price as compared with those made of metal. Since the resistance characteristics of the fluid resistance element can be changed by changing the number of resistance flow paths, it can also be used for ultra-low flow rate measurement for example. In addition, since the resistance flow path can be processed into a circular tube shape, an ideal flow of the fluid is achieved, and various simulations can be simplified.

In this manner, since the outer peripheral face of the flow path forming member is covered with the covering member made of metal, when the fluid resistance element is fitted into a flow path through which the fluid flows, the covering member made of metal serves as a buffer between the wall face forming the flow path and the flow path forming member. Thus, it is possible to dispose the fluid resistance element, without difficulty, in the flow path without damaging the fluid resistance element while enjoying various advantages from forming the resistance flow path using ceramic.

It is preferable that the flow path forming member has a columnar shape, and the covering member has a cylindrical shape into which the flow path forming member is fitted with a fitting tolerance.

With such a configuration, it is possible to construct the flow path forming member and the covering member with a fitting tolerance, and it is easy to assemble the fluid resistance element.

To more reliably prevent damage to the flow path forming member, it is preferable that an entire outer peripheral face of the flow path forming member is covered with the covering member.

To enable measurement of a low flow rate, it is preferable that an aspect ratio that is a ratio of a length dimension to a diameter dimension of the resistance flow path is 200 or more.

A fluid control device according to the present invention includes the above-described fluid resistance element provided in an internal flow path through which a fluid flows, an upstream pressure sensor and a downstream pressure sensor provided on an upstream side and a downstream side, respectively, of the fluid resistance element in the internal flow path, and a flow rate adjustment valve provided in the internal flow path.

Another fluid control device according to the present invention includes the above-described fluid resistance element provided in an internal flow path through which a fluid flows, a sensor flow path that connects an upstream side and a downstream side of the internal flow path, an upstream electric resistance element and a downstream electric resistance element provided in the sensor flow path, and a flow rate adjustment valve provided in the internal flow path.

A differential pressure type fluid control device or a thermal type fluid control device configured as described above, which includes the above-described fluid resistance element, can achieve the same operational effects as those of the fluid resistance element according to the present invention.

More specific configurations include a configuration including a flow rate calculation circuit that calculates a flow rate of a fluid flowing through the internal flow path, and a control circuit that controls the flow rate adjustment valve so that a measured flow rate calculated by the flow rate calculation circuit becomes a predetermined target flow rate.

Examples of the disposition of the fluid resistance elements include an aspect in which a plurality of the fluid resistance elements having different resistance values is provided in series or in parallel.

More specific configurations include a configuration in which the internal flow path is provided with a first pressure sensor, a second pressure sensor, and a third pressure sensor, a first fluid resistance element of the plurality of the fluid resistance elements is provided between the first pressure sensor and the second pressure sensor, a first fluid resistance element of the plurality of the fluid resistance elements is provided between the second pressure sensor and the third pressure sensor, and the fluid control device further includes a diagnostic circuit that compares a first flow rate with a second flow rate to diagnose whether or not a failure has occurred. The first flow rate is calculated based on a resistance value of the first fluid resistance element, a detection value of the first pressure sensor, and a detection value of the second pressure sensor; and the second flow rate is calculated based on a resistance value of the second fluid resistance element, the detection value of the second pressure sensor, and a detection value of the third pressure sensor.

With such a configuration, whether or not a defect has occurred in the fluid control device can be diagnosed by the diagnostic circuit.

Meanwhile, in the case of a small flow rate, a poor fluid separation from the fluid resistance element at the time of falling causes a decrease in responsiveness.

To solve such a problem, it is preferable that the first fluid resistance element is provided between the upstream pressure sensor and the downstream pressure sensor, and the second fluid resistance element is provided in parallel with the first fluid resistance element.

With such a configuration, since the fluid can be forcibly discharged through the second fluid resistance element, the flow rate can be secured, and therefore, the time for falling can be reduced for example from 30 seconds to about 3 seconds.

Examples of another aspect of disposition of the fluid resistance element include an aspect in which a plurality of the fluid resistance elements having resistance values equal to each other is provided in series.

More specific configurations includes a configuration in which the plurality of the fluid resistance elements is provided between the upstream pressure sensor and the downstream pressure sensor.

Such a configuration can increase the resistance between the upstream pressure sensor and the downstream pressure sensor and enables a measurement with a low flow rate.

### Advantageous Effects of Invention

According to the present invention configured as described above, it is possible to incorporate the flow path forming member into a flow path without difficulty while enjoying various advantages from using ceramic as the flow path forming member.

### BRIEF DESCRIPTION OF DRAWINGS

FIG. 1 is a fluid circuit diagram of a fluid control device according to an embodiment of the present invention.

FIG. 2 is a cross-sectional view illustrating an internal structure of the fluid control device of the embodiment.

FIG. 3 is a schematic view illustrating a configuration of a fluid resistance element of the embodiment.

FIG. 4 is a fluid circuit diagram of a fluid control device according to another embodiment.

FIG. 5 is a schematic view illustrating a disposition of a fluid resistance element according to another embodiment.

FIG. 6 is a fluid circuit diagram of a fluid control device according to another embodiment.

### LIST OF REFERENCE CHARACTERS

100 fluid control device
L internal flow path
Pa upstream pressure sensor
Pb downstream pressure sensor
R fluid resistance element
10a internal flow path
flow path forming member
covering member

### DESCRIPTION OF EMBODIMENT

Hereinafter, an embodiment of a fluid resistance element according to the present invention will be described with reference to the drawings.

The fluid resistance element of the present embodiment is one of components of a fluid control device that controls a mass flow rate of material gas or the like used for semiconductor manufacturing, for example.

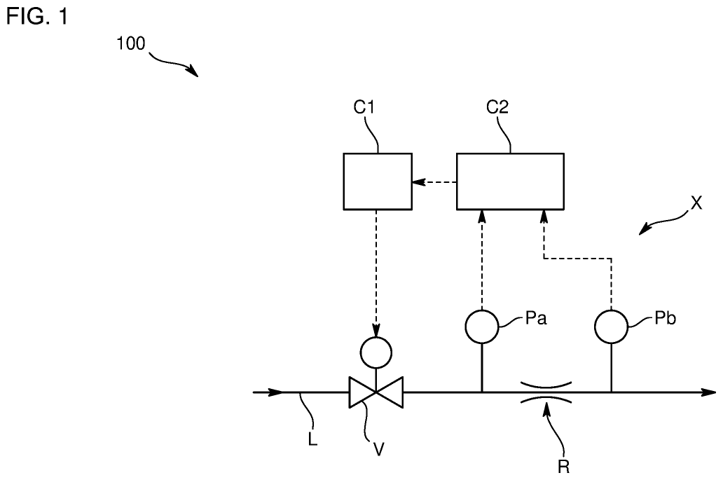

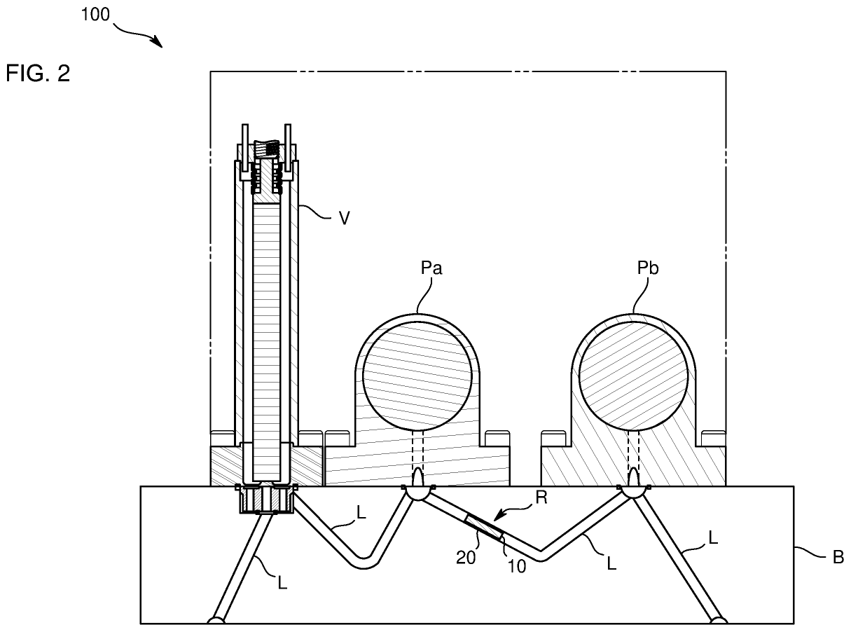

Specifically, as illustrated in the fluid circuit diagram in FIG. 1 and the internal structure in FIG. 2, a fluid control device 100 includes an internal flow path L through which a fluid to be controlled flows, a flow rate adjustment valve V provided on the internal flow path L, a flow rate measurement mechanism X provided on the downstream side from the flow rate adjustment valve V and measuring a flow rate of the fluid flowing through the internal flow path L, and a control circuit C1 (not illustrated in FIG. 2) that controls the flow rate adjustment valve V so that a measured flow rate determined by the flow rate measurement mechanism X becomes a predetermined target flow rate.

The flow rate measurement mechanism X is of a differential pressure type, and includes an upstream pressure sensor Pa provided on the upstream side of the internal flow path L, a downstream pressure sensor Pb provided on the downstream side of the upstream pressure sensor Pa, a fluid resistance element R provided between the upstream pressure sensor Pa and the downstream pressure sensor Pb in the internal flow path L and generating a pressure difference, and a flow rate calculation circuit C2 (not illustrated in FIG. 2) that calculates the flow rate of the fluid flowing through the internal flow path L based on pressure measurement values by the upstream pressure sensor Pa and the downstream pressure sensor Pb and a resistance value of the fluid resistance element R.

A feature of the present embodiment is the fluid resistance element R, which will be described in detail below.

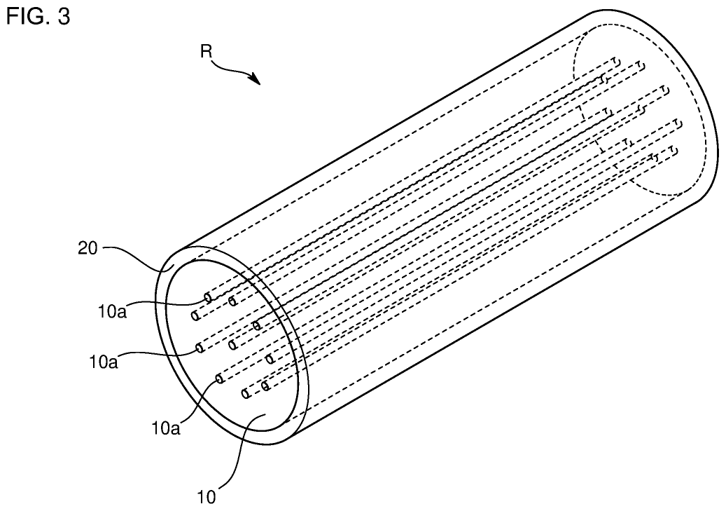

As shown in FIG. 3, the fluid resistance element R serves as resistance when a fluid flows, and specifically includes a flow path forming member 10 made of ceramic having a flow path 10a (hereinafter, also referred to as a resistance flow path 10a) serving as resistance.

The flow path forming member 10 is formed of, for example, a ceramic such as quartz, alumina, zirconia, or silicon nitride, and specifically has a columnar shape, in which about one to several hundred resistance flow paths 10a are formed along its axial direction. Here, the flow path forming member 10 has a diameter dimension (outer diameter) of about several mm (for example, 1.5 mm) and a length dimension (dimension along the axial direction) of about several mm to several tens of mm (for example, 7 mm), but these dimensions may be appropriately changed.

The resistance flow path 10a penetrates the flow path forming member 10 in the axial direction and has a linear shape with a circular cross section, and examples thereof include a resistance flow path formed on a pipe axis of the flow path forming member 10 and a plurality of resistance flow paths regularly disposed around the pipe axis. Here, the resistance flow path 10a has a diameter dimension (inner diameter) of less than 1 mm and about several tens of μm (for example, 30 μm), and a length dimension (dimension along the axial direction) is about several mm to several tens of mm (for example, 7 mm) which is the same as that of the flow path forming member 10, but these dimensions may be appropriately changed.

In the present embodiment, the aspect ratio, which is the ratio of the length dimension to the diameter dimension of the resistance flow path 10a, is 200 or more, and more preferably 300 or more. The resistance value of the fluid resistance element R is determined based on the aspect ratio and the number of the resistance flow paths 10a.

As illustrated in FIG. 3, the fluid resistance element R of the present embodiment further includes a covering member 20 made of metal that covers the outer peripheral face of the flow path forming member 10.

More specifically, the covering member 20 is made of a metal having a hardness lower than that of at least ceramic, such as stainless steel or a nickel-based alloy. Here, the length dimension of the covering member 20 (dimension along the axial direction) is substantially the same as the length dimension of the flow path forming member 10 (dimension along the axial direction), and therefore the entire outer peripheral face of the flow path forming member 10 is covered with the covering member 20.

The covering member 20 of the present embodiment is formed in a cylindrical shape by machining to perforate a metal columnar member with, for example a drill, or drawing, and has an inner diameter within a range of a predetermined fitting tolerance with respect to the outer diameter of the above-described flow path forming member 10. Thus, the covering member 20 is fitted around the flow path forming member 10 by interference fitting, clearance fitting, intermediate fitting, or the like.

The covering member 20 is interposed between a wall face forming the internal flow path L and an outer peripheral face of the flow path forming member 10 (see FIG. 2) in a state where the fluid resistance element R is disposed in the internal flow path L described above, and functions as a cushioning material when the fluid resistance element R is inserted into the internal flow path L.

More specifically, the internal flow path L of the present embodiment is formed by perforating a block body B on which the flow rate adjustment valve V, the upstream pressure sensor Pa, and the downstream pressure sensor Pb described above are placed with a drill or the like, and the fluid resistance element R is disposed in a portion of the internal flow path L where the upstream pressure sensor Pa and the downstream pressure sensor Pb communicate with each other. When the fluid resistance element R is inserted into this portion of the internal flow path L, the covering member 20 is deformed, whereby impact (stress) applied to the flow path forming member 10 is buffered.

According to the fluid resistance element R of the present embodiment configured as described above, since the flow path forming member 10 is made of ceramic, processing can be performed with high dimensional accuracy, and the fluid resistance element R having uniform resistance characteristics can be stably produced. Specifically, for example, by cutting a long (for example, 1 m) ceramic in which the resistance flow path 10a is formed into pieces having a same length (for example, about several mm) and using each of the pieces as the flow path forming member 10, it is possible to produce a lot of fluid resistance elements R having uniform resistance characteristics. On the other hand, when the cutting length is changed, fluid resistance elements having various resistance characteristics can be easily produced, which contributes to, for example, various model designs. Since the flow path forming member 10 is made of ceramic, the flow path forming member can be inserted into the internal flow path L without crushing the resistance flow path 10a, and there are advantages such as a low thermal expansion coefficient, high corrosion resistance, and low price as compared with those made of metal. Since the resistance characteristics can be changed by changing the number of the resistance flow paths 10a, it can also be used for ultra-low flow rate measurement for example. In addition, since the resistance flow path 10a can be processed into a circular tube shape, an ideal flow of the fluid is achieved, and various simulations can be simplified.

In this manner, since the outer peripheral face of the flow path forming member 10 is covered with the covering member 20 made of metal, when the fluid resistance element R is fitted into the internal flow path L, the covering member 20 made of metal serves as a buffer between the wall face forming the internal flow path L and the flow path forming member 10, and it is possible to dispose the fluid resistance element R without difficulty in the internal flow path L without damaging the fluid resistance element R while enjoying various advantages from forming the resistance flow path 10a using ceramic.

When the fluid resistance element R is disposed in the internal flow path L, the covering member 20 is slightly crushed (deformed) between the wall face of the internal flow path L and the outer peripheral face of the flow path forming member 10, which can fix the fluid resistance element R in the internal flow path L.

Since the flow path forming member 10 is covered with the covering member 20, the risk of contamination, damage, or the like of the flow path forming member 10 can be reduced at the time of handling such as during manufacturing or carrying of the fluid resistance element R.

Since the entire outer peripheral face of the flow path forming member 10 is covered with the covering member 20, it is possible to prevent damage to the flow path forming member 10 more reliably that may occur when the fluid resistance element R is inserted into the internal flow path L.

Since the inner diameter of the covering member 20 is within a range of a predetermined fitting tolerance with respect to the outer diameter of the flow path forming member 10, it is possible to construct the flow path forming member 10 and the covering member 20 with a fitting tolerance, and it is easy to assemble the fluid resistance element R.

In addition, since the aspect ratio, which is the ratio of the length dimension to the diameter dimension of the resistance flow path 10a, is 200 or more, it is possible to measure an ultra-low flow rate.

When the fluid resistance element is formed by sandwiching a slit plate with covering plates as in the conventional technology (described in the background art), there is also a problem that a disposition space matched with the shape of the fluid resistance element needs to be separately formed in the middle of the internal flow path L. However, the fluid resistance element R of the present embodiment can be provided in the internal flow path L without difficulty, and it is not necessary to separately form such a dedicated space.

The present invention is not limited to the above embodiment.

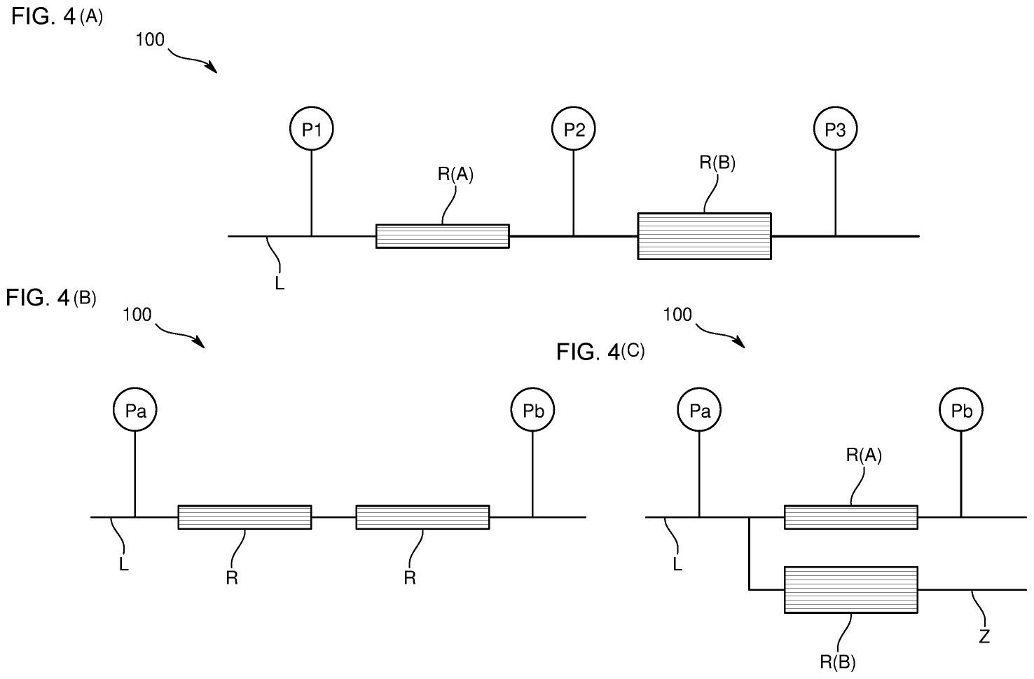

For example, the fluid control device 100 includes one fluid resistance element R in the above embodiment, but it may include a plurality of fluid resistance elements R as illustrated in FIG. 4.

As an example, as shown in FIG. 4(A), an aspect in which a plurality of fluid resistance elements R is provided in series can be given.

Specifically, three or more pressure sensors (hereinafter, first to third pressure sensors P1 to P3) are provided in the internal flow path L, a first fluid resistance element R(A) is provided between the first pressure sensor P1 and the second pressure sensor P2, and a second fluid resistance element R(B) is provided between the second pressure sensor P2 and the third pressure sensor P3.

In such a configuration, the fluid control device 100 preferably includes a diagnostic circuit (not illustrated) that compares a first flow rate calculated based on a resistance value of the first fluid resistance element R(A), a detection value of the first pressure sensor P1, and a detection value of the second pressure sensor P2 with a second flow rate calculated based on a resistance value of the second fluid resistance element R(B), a detection value of the second pressure sensor P2, and a detection value of the third pressure sensor P3, thereby diagnosing whether or not a failure has occurred in the fluid control device 100. As a specific aspect of the diagnostic circuit, an aspect in which the fluid control device is diagnosed as having a failure when a difference between the first flow rate and the second flow rate exceeds a predetermined threshold value can be given.

In addition, as illustrated in FIG. 4(B), by providing a plurality of fluid resistance elements R in series between the upstream pressure sensor Pa and the downstream pressure sensor Pb, it is possible to increase the resistance between the upstream pressure sensor Pa and the downstream pressure sensor Pb and to measure a low flow rate.

As another example, as shown in FIG. 4(C), an aspect in which a plurality of fluid resistance elements R is provided in parallel with each other can be given.

Specifically, the first fluid resistance element R(A) is provided between the upstream pressure sensor Pa and the downstream pressure sensor Pb, and the second fluid resistance element R(B) is provided in a discharge flow path Z branching from the upstream or downstream of the first fluid resistance element R(A).

Such a configuration can secure the flow rate flowing into the fluid control device 100 by discharging a predetermined amount of fluid from the discharge flow path, which can improve the response speed in the case of controlling a small flow rate. More specifically, in the case of a small flow rate, a poor fluid separation from the fluid resistance element R at the time of falling causes a decrease in responsiveness. By providing the first fluid resistance element R(A) and the second fluid resistance element R(B) in parallel as illustrated in FIG. 4(C), the fluid can be forcibly discharged through the second fluid resistance element R(B). This can secure the flow rate, and therefore, the time for falling can be reduced for example from 30 seconds to about 3 seconds.

When the fluid control device 100 includes a plurality of fluid resistance elements R as described above, these fluid resistance elements R may have different resistance or may have equal resistance.

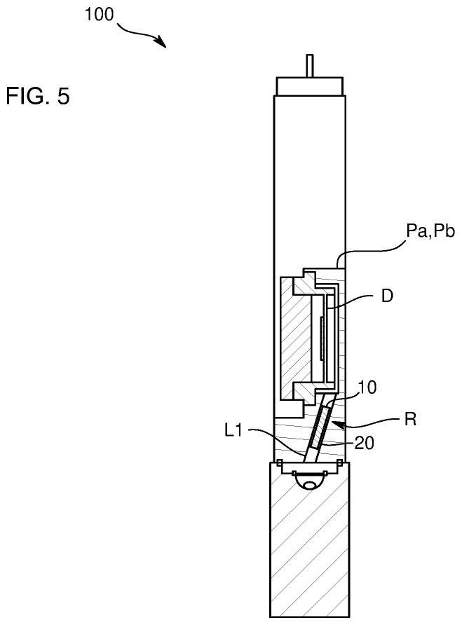

Although the fluid resistance element R is provided in the internal flow path L communicating the upstream pressure sensor Pa and the downstream pressure sensor Pb in the above embodiment, the fluid resistance element R may be incorporated in the upstream pressure sensor Pa or the downstream pressure sensor Pb as illustrated in FIG. 5. Specifically, the fluid resistance element R may be provided in a flow path L1 for guiding the fluid to a diaphragm D, which is a component of a pressure sensor.

In the above embodiment, the flow path forming member 10 is fitted to the cylindrical covering member 20; however, for example, the covering member 20 made of metal may be wound around the outer peripheral face of the flow path forming member 10, or the covering member 20 made of metal may be provided on the outer peripheral face of the flow path forming member 10 by surface treatment such as vapor deposition.

Besides, the flow path forming member 10 has a columnar shape in the above embodiment, but when the transverse section of the flow path has a triangular, quadrangular, or polygonal shape, the flow path forming member 10 may also have a columnar shape having a triangular, quadrangular, or polygonal transverse section in accordance with these shapes. In such a case, the covering member 20 may also have a tubular shape having a triangular, quadrangular, or polygonal transverse section corresponding to the transverse sectional shape of the flow path.

The fluid control device 100 may be another device unit such as a flow meter (flow rate measuring device) without the flow rate adjustment valve V.

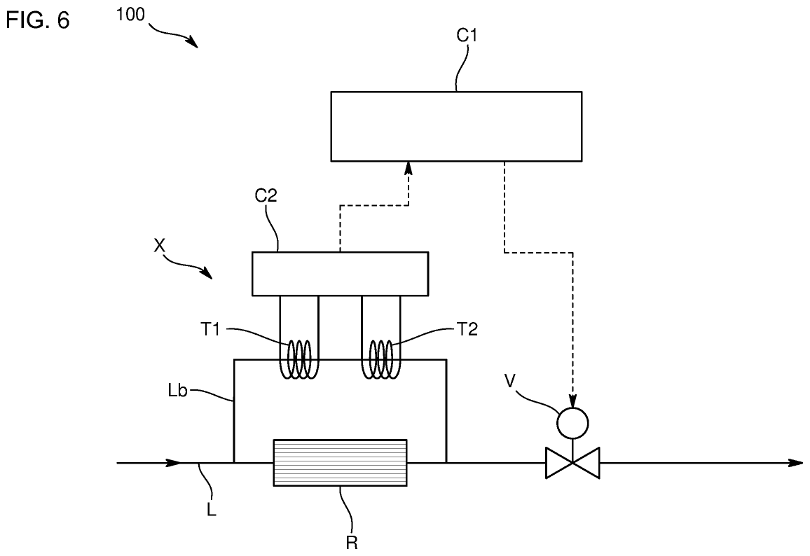

In the above embodiment, the fluid control device 100 of a pressure type is configured as the fluid resistance element R. However, as illustrated in FIG. 6, a thermal type fluid control device 100 in which a thermal type flow rate sensor is provided in the internal flow path L may be configured. Specifically, the flow rate measurement mechanism X in such a case includes the fluid resistance element R provided in the internal flow path L, a sensor flow path Lb connecting the upstream side and the downstream side in the internal flow path L, an upstream electric resistance element T1 and a downstream electric resistance element T2 provided in the sensor flow path Lb, and a flow rate calculation circuit C2 that calculates the flow rate of the fluid based on values output from these electric resistance elements T1 and T2.

The present invention is not limited to the above embodiment, and it is needless to say that various modifications can be made without departing from the gist of the present invention.

### INDUSTRIAL APPLICABILITY

According to the present invention, it is possible to incorporate the fluid resistance element into a flow path through which the fluid flows without difficulty while enjoying advantages from forming the resistance flow path using ceramic.

1. A fluid resistance element comprising:
a flow path forming member made of ceramic and having one or a plurality of resistance flow paths; and
a covering member that is made of metal and covers an outer peripheral face of the flow path forming member.

2. The fluid resistance element according to claim 1, wherein
the flow path forming member has a columnar shape, and
the covering member has a cylindrical shape into which the flow path forming member is fitted with a fitting tolerance.

3. The fluid resistance element according to claim 1, wherein an entire outer peripheral face of the flow path forming member is covered with the covering member.

4. The fluid resistance element according to claim 1, wherein an aspect ratio that is a ratio of a length dimension to a diameter dimension of the resistance flow path is 200 or more.

5. A fluid control device comprising:
the fluid resistance element according to claim 1 provided in an internal flow path through which a fluid flows;
an upstream pressure sensor and a downstream pressure sensor provided on an upstream side and a downstream side, respectively, of the fluid resistance element in the internal flow path; and
a flow rate adjustment valve provided in the internal flow path.

6. A fluid control device comprising:
the fluid resistance element according to claim 1 provided in an internal flow path through which a fluid flows;
a sensor flow path that connects an upstream side and a downstream side of the internal flow path;
an upstream electric resistance element and a downstream electric resistance element provided in the sensor flow path; and
a flow rate adjustment valve provided in the internal flow path.

7. The fluid control device according to claim 5, comprising:
a flow rate calculation circuit that calculates a flow rate of a fluid flowing through the internal flow path; and
a control circuit that controls the flow rate adjustment valve so that a measured flow rate calculated by the flow rate calculation circuit becomes a predetermined target flow rate.

8. The fluid control device according to claim 5, wherein a plurality of the fluid resistance elements having different resistance values is provided in series or in parallel.

9. The fluid control device according to claim 8, wherein
the internal flow path is provided with a first pressure sensor, a second pressure sensor, and a third pressure sensor,
a first fluid resistance element of the plurality of the fluid resistance elements is provided between the first pressure sensor and the second pressure sensor, and
a second fluid resistance element of the plurality of the fluid resistance elements is provided between the second pressure sensor and the third pressure sensor,
the fluid control device further comprising
a diagnostic circuit that compares a first flow rate with a second flow rate to diagnose whether or not a failure has occurred, the first flow rate being calculated based on a resistance value of the first fluid resistance element, a detection value of the first pressure sensor, and a detection value of the second pressure sensor, the second flow rate being calculated based on a resistance value of the second fluid resistance element, the detection value of the second pressure sensor, and a detection value of the third pressure sensor.

10. The fluid control device according to claim 8, wherein
the first fluid resistance element is provided between the upstream pressure sensor and the downstream pressure sensor, and
the second fluid resistance element is provided in parallel with the first fluid resistance element.

11. The fluid control device according to claim 5, wherein a plurality of the fluid resistance elements having resistance values equal to each other is provided in series.

12. The fluid control device according to claim 11, wherein the plurality of the fluid resistance elements is provided between the upstream pressure sensor and the downstream pressure sensor.
